(19) United States
(12) Patent Application Publication
(10) Pub. No.: US 2023/0297088 A1
(43) Pub. Date: Sep. 21, 2023

(54) METHOD FOR SELF-LEARNING MANUFACTURING SCHEDULING TRAINING, COMPUTER PROGRAM PRODUCT AND REINFORCEMENT LEARNING SYSTEM

(71) Applicant: Siemens Aktiengesellschaft, München (DE)

(72) Inventors: Danielle Turner, Nürnberg (DE); Schirin Bär, Fürth (DE); Felix Bär, Fürth (DE); Sebastian Pol, Seukendorf (DE)

(21) Appl. No.: 18/021,255

(22) PCT Filed: Aug. 27, 2020
(86) PCT No.: PCT/EP2020/074024

§ 371 Date: Feb. 14, 2023

(51) Int. Cl. G05B 19/418

(52) U.S. Cl. CPC G05B 19/41865; G05B 2219/42152

(57) ABSTRACT

A procedure to train an online scheduling system using Reinforcement Learning agents to process any kind of product variant and any kind of machine configuration is disclosed. The novel approach of scheduling jobs or products in a flexible manufacturing system is to train Deep Reinforcement Learning agents with generated training data. One agent may represent a product and may autonomously guide the product through the manufacturing system, including decisions regarding resource allocations (which module should process which operation) and transport decisions. Dependent on the mode to be trained, the identical job-specification for same, job-specifications from the same cluster for similar, and job-specifications from different clusters for different are chosen. This solution may handle any product variant to be produced within the considered system.

The present patent document is a § 371 nationalization of PCT Application Serial No. PCT/EP2020/074024, filed Aug. 27, 2020, designating the United States, which is hereby incorporated by reference.

### TECHNICAL FIELD

A flexible manufacturing system (FMS) is a production method configured to easily adapt to changes in the type and quantity of the product being manufactured. Machines and computerized systems may be configured to manufacture a variety of parts and handle changing levels of production. Methods, computer program products, and systems for self-learning manufacturing scheduling training for a FMS are disclosed herein.

### BACKGROUND

In the area of production scheduling, there are various conventional approaches to dispatch jobs and/or products to machines. In recent years, there are also more and more AI-based approaches to learn suitable schedules for different situations. In both approaches, the high number of product variants to be handled in today's flexible manufacturing systems FMS introduces huge complexity to the system. Continuously changing market conditions force manufacturers to cope not only with the high number of product variants, but also with the requirement of being able to produce a new product variant if desired.

In some cases, the existing manufacturing system may process this new product variant without the need of reconfiguration of the hardware. Products may be described in such a way that the scheduling system may understand the requirements (e.g., by the bill of material BOM, the bill of processes BOP).

A “bill of materials or product structure” (sometimes associated list) is a list of the raw materials, sub-assemblies, intermediate assemblies, sub-components, parts, and the quantities of each needed to manufacture an end product.

The “bill of processes” BOP includes detailed plans explaining the manufacturing processes for a particular product. Within these plans resides in-depth information on machinery, plant resources, equipment layout, configurations, tools, and instructions.

Conventional scheduling systems might still be able to handle the new product feature directly, because of the underlying heuristic or rules that apply to the new BOM and BOP as well. Otherwise, engineering effort is needed to adjust the heuristic or rules.

AI-based scheduling systems may only be trained for the considered product variants and need to be retrained in the case of introducing new product variants to the system, which goes along with engineering effort and time in which the production cannot be used.

In many cases, the manufacturer reconfigures the system by extending the skills provided by a machine or module by introducing new material, a new tool, or by adjusting the automation program. The other option is to introduce a completely new machine that may process the new required product variant. In both options, the manufacturer needs to introduce the changes and new information into the production control system that includes the scheduling system, so that the according new job may be scheduled to the adjusted or new machine properly. This also goes along with engineering effort and time needed for the adjustment.

In summary, scheduling systems must be able to handle a high number of product variants and also entirely new product variants, but therefore require reconfiguration together with production downtime, which may be also a problem for the manufacturer.

Conventional scheduling systems are reconfigured manually, e.g., by adjustment of heuristic or rules, which involves engineering effort and time.

Reinforcement Learning solutions are trained for the specific product variants considered and need to be retrained for new product variants, which involves engineering effort and time.

Autoencoders that are trained for specific product variants are also retrained for new product variants or machine configurations.

Two of the main methods used in unsupervised learning are principal component and cluster analysis. Cluster analysis is used in unsupervised learning to group, or segment, datasets with shared attributes in order to extrapolate algorithmic relationships. Cluster analysis is a branch of machine learning that groups the data that has not been labelled, classified or categorized. Instead of responding to feedback, cluster analysis identifies commonalities in the data and reacts based on the presence or absence of such commonalities in each new piece of data. Such commonalities are also referred to as classes in the following.

### SUMMARY

The scope of the present disclosure is defined solely by the appended claims and is not affected to any degree by the statements within this summary. The present embodiments may obviate one or more of the drawbacks or limitations in the related art.

It is purpose of the disclosure to offer a new method for training of Reinforcement Learning Networks, especially the generation and rating of newly generated test data into test classes.

This object is accomplished according to the present disclosure by a method, a computer program product, and a Reinforcement Learning System as disclosed herein.

The disclosure is based on a procedure to train an online scheduling system using Reinforcement Learning (RL) agents to process any kind of product variant and any kind of machine configuration.

The novel approach of scheduling jobs or products in a flexible manufacturing system (FMS) is to train Deep Reinforcement Learning (RL) agents with generated training data. One agent may represent a product and may autonomously guide the product through the manufacturing system, including decisions regarding resource allocations (which module should process which operation) and transport decisions.

When an agent represents a product, it needs to know at least about the job it is handling, or rather the product it should produce. In our solution, the so-called job-specification contains this information including the machines or modules and their properties that may be used for each operation of the job.

In a job-specification, each operation is labeled by one or more elements [M, P] where M references a manufacturing module and P is the property such as the corresponding processing time or energy consumption. An example of a job-specification looks like this:
[[[2, 1], [5, 8]],
[[2, 4], [4, 5]],
[[6, 9], [1, 3]],
[[3, 7], [5, 1]]].

In this example, the job-specification includes four operations. Each operation may be processed by two distinct modules. The first operation may either be completed by the second module in one time-unit or by the fifth module in eight time-units.

### BRIEF DESCRIPTION OF THE DRAWINGS

The disclosure is elaborated in the figures, in which:

FIG. 1 depicts an Overview and example summary of the acts involved in the procedure, and

FIG. 2 depicts a more detailed presentation with example values for the job specifications.

### DETAILED DESCRIPTION

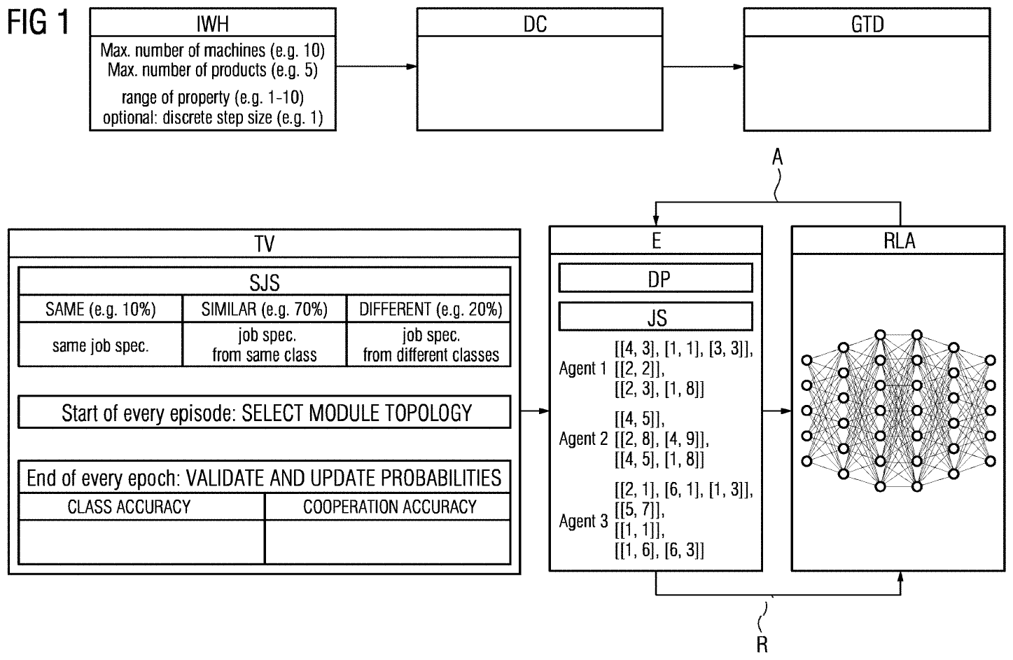

The procedure, shown in FIG. 1, includes an act where hyperparameters are set during the initialization of our procedure. In this act: a maximum number of machines or modules (M1, . . . M6) is defined that is wanted to be considered (now and in the future, e.g., 10 or 100); the range of properties of these machines or modules is defined, the properties are scaled in a specific range, e.g., from 1-10; the maximum number of products that should be considered is defined, e.g., 5; and a discrete step size, might be optional, e.g., 1.

In the procedure, the complexity of the system is obtained in the first act by the number of machines and products that should be considered. Using prior-knowledge, (e.g., a look-up table), the number of different types of job-specifications is determined, or a number of classes n are determined, that are needed to generate for the training.

The second act of the method determines which kind of job-specifications should be generated and used for the training to achieve an optimal generalization to product variances.

Job-specifications are generated randomly based on the named hyperparameters, such as: number of machines, range of properties, step size and number of products.

Job-specifications are generated with random machines and random properties for each operation.

In the following act, at least m×n job-specifications are generated with the goal to get m samples for each class. For example, with m=100 samples for each of the n=600 classes, 600,000 job-specifications would be generated for one training set.

These 600,000 job-specifications are not used directly. Instead, the third act of the method includes reducing the dimensions of the job-specification using a dimensionality reduction algorithm, for example, PCA (Principal Component Analysis), or T-SNE (T-distributed Stochastic Neighbor Embedding), and the job-specifications are clustered by the 600 classes to check whether 100 samples per class have been generated. Additional samples in each class may be discarded randomly. Acts two and three of the method may be repeated until 100 samples per class are obtained.

In a next advantageous, optional act four, half of the m samples of each class are selected and stored in the training set, e.g., m/2=50 samples. The other half is stored for validation purposes.

Act five describes the actual training procedure TV. Each epoch SJS, in the example, 1 out of the 50 samples may be randomly selected for each agent AG that controls a product 1. The class (SAME, SIMILAR, DIFFERENT), from which this is selected, is chosen using a probability system which is adapted between each epoch, described in further detail in the description of acts six and seven.

The procedure features the differentiation of the training mode between three options. The agents may be trained to handle identical job-specifications (SAME), which would happen in the factory when multiple products of one kind should be produced at the same time. Further, the agents may be trained on similar job-specifications (SIMILAR), which forces the agents to cooperate during their decision-making, because they possibly need to share machines and need to take alternatives if possible, to achieve a good overall efficiency beside their own goals. Lastly, the agents may be trained on different job-specifications (DIFFERENT), where they possibly need different machines to fulfil their job.

Dependent on the mode we want to train, the identical job-specification for same, job-specifications from the same cluster for similar and job-specifications from different clusters for different are chosen. Hyperparameters are used that determine the probability of the used training mode and these hyperparameters are updated based on the performance of the agents VAL. High probability means that this training mode does not perform well yet, meaning it should be chosen again with a high probability, as more training is required to improve the results.

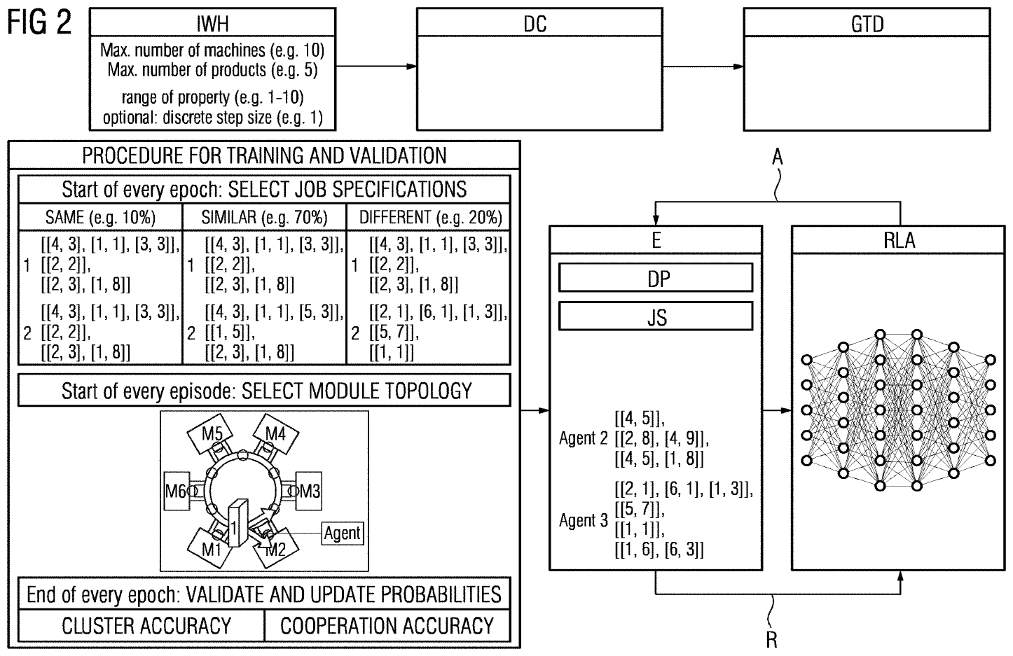

An example scenario is given of the selection of the training samples of act five (see also FIG. 2).

The probability distribution of training modes is:
10% identical,
70% similar and
20% different.
30 classes out of the 600 are performing equally badly and the other 570 are performing equally well.

Therefore, each of the badly performing classes may have a probability of 2%, and each of the suitably performing classes may have a probability of around 0.07% (30*2%+570*0.07%-100%).

This would lead to the badly performing classes being chosen in 60% (30*2%) of cases. For more focused training, this probability may be further biased to choose badly performing classes.

Example values for the different job specification classes

SAME:
1:
[[4, 3], [1, 1], [3, 3]]
[[2, 2]]
[[2, 3], [1, 8]]
2:
[[4, 3], [1, 1], [3, 3]]
[[2, 2]]
[[2, 3], [1, 8]]

SIMILAR:
1:
[[4, 39], [1, 1], [3, 3]],
[[2, 2]],
[[2, 39], [1, 8]],
2:
[[4, 39], [1, 1], [5,3]],
[[1, 5]]
[[2, 39], [1, 8]],

DIFFERENT:
1:
[[4, 3], [1, 1], [3, 3]]
[[2, 2]]
[[2, 3], [1, 8]]
2:
[[2, 1], [6, 1], [1, 3]]
[[5, 7]]
[[1, 1]]

In the example of FIG. 2, three agents are trained at the same time. For the next training epoch, with 70% probability, the procedure would select 3 job-specifications JS out of one of the classes, and with only 20% it would select 3 job-specifications out of 3 different classes for the digital production DP.

The data for the Agents on the Reinforcement Learning Network RLA by Action A and Reward R may then be as follows:

Agent 1:
[[4, 3], [1, 1], [3, 3]]
[[2, 2]]
[[2, 3], [1, 8]]

Agent 2:
[[4, 5]]
[[2, 8], [4, 9]]
[[4, 5], [1, 8]]

Agent 3:
[[2, 1], [6, 1], [1, 3]]
[[5, 7]]
[[1, 1]]
[[1, 6], [6, 3]]

These randomized job-specifications are used within the training process to train Deep Reinforcement Learning agents RLA to control products including dispatching to machines. A proper reward function guides the Reinforcement Learning agent to search a suitable policy according to the known RL method, e.g., those published by Sutton, R. S. & Barto, A. G. (2018), Reinforcement Learning: An Introduction, The MIT Press.

Three combinations of randomly generated job-specifications are used during training to make the agent learn to interpret the meaning of the job-specification. The first value is the first machine that may process the next operation, the second value is the property of this machine, the third value is the second machine that may process the current operation, . . . etc.

With the characteristic of using a neural network as a function approximator in combination with Reinforcement Learning, agents may generalize the seen input. In the procedure disclosed herein, the Reinforcement Learning agents generalize the job specifications so that the agents may handle any combination of machines that may process a certain operation, independent from the ones seen during training.

Acts six and seven, e.g., after one epoch of training, involve the validation VAL of the classes and training modes, respectively.

The agents are validated in a single agent setting by using v validation samples for each class, e.g., 10 samples. These 10 samples are randomly chosen samples from the 50 samples of each class that were not used during training. A rating of the performance is determined for each class and update the share of the probability of each class used during the training based on the relative performance of the agent per class. For example, the percentage incompletion of the respective job specifications may be used. In the simplified case of only two classes, should one class have an average incompletion percentage of 75% and the other class have an average incompletion percentage of 50%, the resulting probabilities would be 60% and 40% respectively (calculated using incompletion percentage/sum of all average incompletion percentages for all classes). In the initialization, the probability distribution is set equally.

Act seven then validates the three training modes in a multi-agent validation set-up. For each training mode, w validation samples are used, e.g. 10 samples, and the agents are rated based on their performance and the probability share is updated consequently. A metric may be to use the errors performed within the 10 samples per class, e.g., 1, 2, 5 errors for each class respectively would lead to a ⅛, 2/8, ⅝ probability share, where 8 is the total number of errors for all classes.

Besides the selection of the job-specification, which is done every epoch, a random module topology is selected every episode within the epoch from the set of module topologies that we randomly generated based on the number of machines we are considering. That means, for example, that the sequential order of the used modules M1, . . . M6 is changed within the FMS.

A stopping criterion of the training may be defined as the same probability distribution across all classes (within an allowed tolerance), with an error rate below 1.

With this procedure, an efficient training process is obtained, which is optimized to train the agents for situations they are not yet performing well and with the option to choose different training modes. Furthermore, the agents are prepared to handle all upcoming product variants and machine adjustments. The option is available to provide specific job-specifications of the considered manufacturing system and replace one class out of the n classes with the specific job-specifications. Thereby, it is provided that the agents are trained specifically for the considered system and additionally prepared for any upcoming variant.

For any change of machines, (e.g., reconfiguration of the machine topology, introducing of a new machine, or extending the skills of an existing machine, for example, by new material), this solution may be used without engineering effort to reconfigure or retrain.

Another advantage of the proposed solution is that for any change of machines or modules, and for any new product feature, no waiting time is needed, because this solution may immediately deal with any changes of machines.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for self-learning manufacturing scheduling training for a flexible manufacturing system learned by a reinforcement learning system of the flexible manufacturing system, wherein the flexible manufacturing system is configured to produce at least one product, wherein the flexible manufacturing system comprises processing modules that are interconnected, wherein each product of the at least one product is represented by one agent that is described by a job specification, the method comprising:
generating training data randomly on a basis of a set hyperparameter regarding the flexible manufacturing system;
sorting the generated training data into training classes; and
randomly selecting, during the training, one set of training data from a training class of the training classes.

2. The method of claim 1, wherein each agent autonomously guides a respective product through the flexible manufacturing system, including decisions regarding allocation of resources and transport to the resources.

3. The method of claim 2, wherein the respective agent uses job-specification information about the processing modules available and properties of the processing modules for operation of a job.

4. The method of claim 1, wherein named hyperparameters comprise information about a number of processing modules, a range of properties or processing modules, a step size and number of products, or a combination thereof.

5. The method of claim 1, wherein at least m×n job-specifications are generated, where m is a number of samples and n is a number of test classes.

6. The method of claim 5, wherein half of the m samples of each class are selected and stored in a training set, and
wherein the other half of the m samples is stored for validation purposes to be used in a validating act.

7. The method, of claim 1, wherein the training classes from which training data is selected is chosen using a probability system.

8. A non-transitory computer program product for manufacturing scheduling training for a flexible manufacturing system comprising processing modules that are interconnected, wherein the computer program product, when executed by a processing module of processing modules of the flexible manufacturing system, is configured to:
generate training data randomly on a basis of a set hyperparameter regarding the flexible manufacturing system configured to produce at least one product, wherein each product of the at least one product is represented by one agent that is described by a job specification;
sort the generated training data into training classes; and
randomly select, during the training, one set of training data from a training class of the training classes.

9. A flexible manufacturing system comprising:
processing modules that are interconnected; and
a reinforcement learning system configured to train a manufacturing scheduling of the flexible manufacturing system,
wherein the flexible manufacturing system is configured to produce at least one product,
wherein each product of the at least one product is represented by one agent that is described by a job specification,
wherein the reinforcement learning system is configured to use training data generated randomly on a basis of a set hyperparameter regarding the flexible manufacturing system,
wherein the reinforcement learning system is configured to sort the training data into training classes, and
wherein, during the training, the reinforcement learning system is configured to randomly select one set of training data from a training class of the training classes.

10. The method of claim 2, wherein named hyperparameters comprise information about a number of processing modules, a range of properties or processing modules, a step size and number of products, or a combination thereof.

11. The method of claim 10, wherein at least m×n job-specifications are generated, where m is a number of samples and n is a number of test classes.

12. The method of claim 11, wherein half of them samples of each class are selected and stored in a training set, and
wherein the other half of them samples is stored for validation purposes to be used in a validating act.

13. The method of claim 12, wherein the training classes from which training data is selected is chosen using a probability system.

14. The method of claim 2, wherein at least m×n job-specifications are generated, where m is a number of samples and n is a number of test classes.

15. The method of claim 14, wherein half of them samples of each class are selected and stored in a training set, and
wherein the other half of them samples is stored for validation purposes to be used in a validating act.

16. The method of claim 2, wherein the training classes from which training data is selected is chosen using a probability system.
